(19) United States
(12) Patent Application Publication
(10) Pub. No.: US 2003/0105737 A1
(43) Pub. Date: Jun. 5, 2003

(54) Method for the online transformation of bulk data

(76) Inventors: Bernd Hekele, Vagen (DE); Johann Zeiner, Dachau (DE); Ricarda Zengerle, Muenchen (DE)

Correspondence Address: Morrison & Foerster LLP, Suite 300, 1650 Tysons Boulevard, McLean, VA, 22102, US

(21) Appl. No.: 10/183,982

(22) Filed: Jun. 28, 2002

(30) Foreign Application Priority Data
Jun. 28, 2001 (EP) 01115829.2

(51) Int. Cl. G06F 7/00

(52) U.S. Cl. 707/1

(57) ABSTRACT

When upgrading exchanges to a new software version, the data required for controlling the installation is converted to a format which is executable in the new version. The redundancy existing in the installation is utilized by continuing active operation without restrictions on one of the redundant systems, while a second one of the redundant systems is equipped with the new software version. By using a communication channel to request and transform the data from system, possibly with planning data added to them, and to store them in the data area in the system. Following complete and successful data transfer and transformation, the active operation is changed over from system to system and the redundancy of the installation is restored again by removing the isolation between the systems and using known mechanisms to copy system to system.

### CLAIM FOR PRIORITY

This application claims priority to Application No. 01115829.2 which was filed in the German language on Jun. 28, 2001.

### TECHNICAL FIELD OF INVENTION

The invention relates to an on-line transformation of data when changing the software in a data processing installation having relevant systems.

### BACKGROUND OF THE INVENTION

When upgrading exchanges to a new software version, the data required for controlling the installation need to be converted to a format which is executable in the new version. The data are bulk data, possibly millions of data records, since each subscriber or connecting line has one data record available, for example.

Using the known methods, the conversion of these data requires a turnaround time of several days or weeks and can lead to restrictions in operation and to intermittently reduced functionality for the subscribers.

In one known method for transforming data, the data are first translated back into the input language. The data available in the input language are then converted outside the exchange into a form which is suitable for the new software version. Next, the converted data available in the input language are incorporated into the new software version. A serious drawback of this method is the extremely long turnaround times for converting the databases into the input language and back, and the associated restrictions. By way of example, it is not possible to make changes to the subscriber data, to allocate new services or to set up new subscribers during this procedure.

### SUMMARY OF THE INVENTION

In one embodiment of the invention, there is a method for transforming bulk data which avoids the drawbacks of the known methods.

An advantage of the inventive method is that utilization of the redundant architecture of the data processing installation eliminates the need for external processing of the data, and hence the time-consuming process of converting them into a form easily interpreted by the user of the input language and transfer to the external system and back are dispensed with.

Another advantage is that the data in the data processing system are subject to a modification block for a short time.

Another advantage is the structure of the data for the new software version in the second system. If transformation of the data fails, the procedure can be terminated and normal operation of the data processing installation can be continued after software and data have been copied from the first system to the second system, and hence the redundancy has been restored.

### BRIEF DESCRIPTION OF THE DRAWINGS

The inventive method is explained below in more detail with respect to the drawing.

FIG. 1 shows a schematic illustration of the flow of the inventive method.

### DETAILED DESCRIPTION OF THE PREFERRED EMBODIMENT

The redundantly designed systems A₁, A₂ in the data processing installation A—in one exemplary embodiment an exchange—are first separated into two independent, nonredundant systems A₁ and A₂. After this separation, both software and the data in the database DB for the data processing installation A are available in A₁ and A₂, which means that both A₁ and A₂ can perform the function of the data processing installation A.

One of the two systems A₁, A₂—in this exemplary embodiment A₁—is selected to continue the function of the data processing installation A. The system A₁ ensures undisturbed operation of the data processing installation A, while at the same time modifications can be made in the system A₂ without such modifications impairing the operation of the system A₁.

Both systems A₁, A₂ include a database management system DBMS which is used for access operations to the databases DB and DB_{new}. A communication channel used for transferring data and control information between the two systems A₁, A₂is connected between the two systems.

To transfer the data from the system A₁ with the old software version to the system A₂ with the new software version, two different methods are required, depending on the type of the respective data.

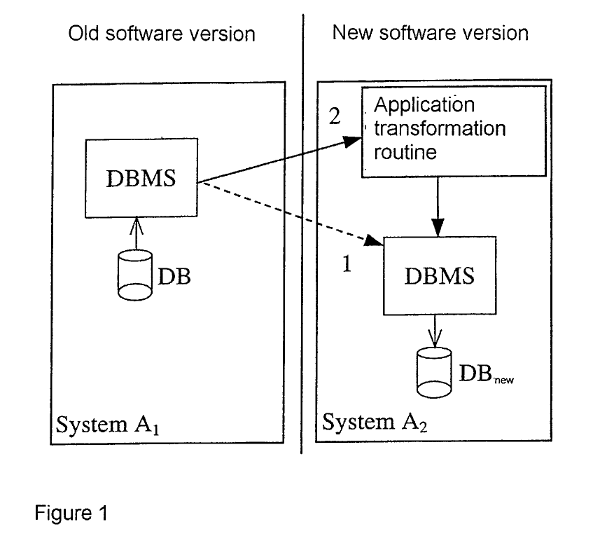

A first portion of the data is transferred unmodified in terms of structure and content from the database DB, which can be used with the old software version in system A₁, to the database DB_{new}, which can be used with the new software version in system A₂. To this end, the data are requested directly from DBMS in A₁ by DBMS in A₂ and are incorporated into the database DB_{new}. This procedure is denoted by numeral 1 in FIG. 1.

A second, larger portion of the data—e.g. data whose format/structure changes when the software version changes, or data which have planning data added to them, or data which are not necessary in the new software version—is modified for incorporation into the database DB_{new}. To this end, the application software components processing the appropriate data during normal operation of the new software version request their associated data from DBMS in A₁ and transform them. This procedure is denoted by numeral 2 in FIG. 1. Next, the data are transferred to DBMS in A₂ for incorporation into DB_{new}. For this purpose, the applications are equipped with the ability to accept the data from an earlier software version and to transform them.

To keep the stock of data in the data processing installation A as up-to-date as possible, modifying access operations to the database DB in the system A₁ are permitted during the transfer and transformation (described above) of the data from system A₁ with the old software version to system A₂ with the new software version, and these access operations are noted in a record file. After completion of transfer and transformation, the method described is used to incorporate the latest state, existing in the database DB in system A₁, into the database DB_{new} in system A₂ by retransferring and transforming the data listed in the record file, the database DB in system A₁ then being blocked to modifying access operations.

Following successful completion of data transfer and transformation from the database DB to the database DB_{new}, the communication channel between the systems A₁ and A₂ is closed and system A₂ starts active operation, while at the same time system A₁ stops active operation, i.e. active operation is switched over from system A₁ to system A₂For security reasons, at this point it is possible to carry out trial operation with system A₂ and the new software version and the transformed data, while system A₁ is available as a backup system—but no longer with the most up-to-date data.

Following completion of the trial operation—or directly after system A₂ has started active operation—both software and data are copied from system A₂ to system A₁ in order to restore the redundancy of the data processing installation A. This is done using known methods which are not the subject matter of this invention.

What is claimed is:

1. A method for the online transformation of data when changing the software in a data processing installation equipped with redundant systems, comprising:
performing a current function of a data processing installation with the data and a current version of the software using a first redundant system;
equipping a second redundant system with current software;
setting up a communication path between the first system and the second system;
extracting the data from the first system via a communication channel using a process incorporated in the current software and is executed on the second system;
transforming the data on the second system for use with the current software;
storing the data in a data area in the second system, and modifications to the data stored in a record file;
storing the data in a data area in the second system, and modifications to the data are stored in a second file;
extracting, transforming and storing data from the record file which have been modified, with changes to the data in the first system not simultaneously permitted; and
restoring a normal function of the data processing installation by starting an operation with the second system and transferring the software and the data in the second system to the first system.

2. The method as claimed in claim 1, wherein data required for operating the data processing installation with the software and which are not available in the first system are generated on the basis of presets, by a process executing on the second system and are stored in the data area in the second system.

3. The method as claimed in claim 1, wherein data no longer required for operating the data processing installation with the software and which are available in the first system are discarded on the basis of presets, by a process executing on the second system and are not transferred to the data area in the second system.

4. The method as claimed in one of claim 1, wherein the change of software is controlled by remote control.

5. The method as claimed in one of claim 1, wherein the data processing installation is an exchange.
